(19) United States
(12) Patent Application Publication
(10) Pub. No.: US 2007/0112106 A1
(43) Pub. Date: May 17, 2007

(54) Photosensitive resin composition

(76) Inventor: Nobuaki Otsuki, Suita-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/599,350

(22) Filed: Nov. 15, 2006

(30) Foreign Application Priority Data
Nov. 16, 2005 (JP) 2005-332101

(51) Int. Cl. C08K 5/15

(52) U.S. Cl. 524/114

(57) ABSTRACT

To provide a photosensitive resin composition satisfying both of the sensitivity at the time of exposure and alkali developability as well as giving a cured material excellent in dimensions stability and scarcely exhibiting brittleness while keeping good heat resistance. The photosensitive resin composition contains a polymer (A) having an N-substituted maleimide group, a carboxyl group, and an ethylenic unsaturated double bond at a ratio less than 0.05 moles per 100 parts by mass of the polymer.

### BACKGROUND OF THE INVENTION

1. Field of the Invention

The invention relates to a photosensitive resin composition useful for image formation.

2. Description of the Related Art

Being finely processable by employing the principle of photolithography and usable for image formation by giving a cured product with excellent physical properties, a photosensitive resin composition for image formation has been employed widely for various kinds of resist materials and printing plates relevant to electronic parts. There are a solvent development type and an alkali development type of the photosensitive resin composition for image formation. In these years, in terms of the environmental measures, the alkali development type developable with an aqueous diluted and weakly alkaline solution has become dominant and the alkali development type photosensitive resin composition has been employed in, for example, printed circuit substrate manufacture, liquid crystal display fabrication, printing plate production, and the like.

In the case the photosensitive resin composition for image formation is used for the process of photolithography as a resin composition for liquid state development type solder resist resin composition, a series of steps are employed, that is at first the resin composition is applied to a substrate and successively heated and dried for forming a coating film. After that, a film for pattern formation is covered on the coating film and then exposure and development treatments are carried out. In such process, if the coating film has remaining adhesiveness after the heat drying, a portion of resist adheres to a film for pattern formation to be carried out successively after separation and it results in inhibition of accurate pattern reproduction or impossibility of separation of the film for pattern formation. Therefore, the tack-free property after the coating film formation is a very important and indispensable property for the liquid state development type resist.

Further, photosensitivity at the time of exposure and developability after exposure are also important and indispensable properties. That is, in order to form a fine pattern with high reliability and reproducibility, at the time of development, the parts cured by exposure may not be eroded with a developer liquid and on the contrary, the un-exposed parts have to be removed quickly at the time of development.

Further, the cured parts are required to have heat resistance for treatment steps (in the case of solder resist, a soldering step and the like) to be carried out under high temperature condition thereafter and properties relevant to long term reliability such as water resistance and moisture resistance.

As an example which satisfies the above-mentioned various properties to a certain extent, it is known that there is a carboxyl group-containing epoxy (meth)acrylate obtained by introducing a carboxyl group by reaction of an acid anhydride with an epoxy (meth)acrylate obtained by reaction of an epoxy resin and (meth)acrylic acid. The carboxyl group-containing epoxy (meth)acrylate well satisfies the contradictory properties such as tack-free property, photosensitivity, and developability in good balance and also has important properties relatively well such as heat resistance and water resistance required in form of a cured material. However, along with the advancement of the techniques, further higher properties have been required. For example, dimensions stability so high as to satisfy the fine pattern formation and durability to treatments in higher temperature condition are required.

With respect to the above-mentioned epoxy (meth)acrylate, it may be possible to introduce a large number of double bonds into the resin skeleton by using a polyfunctional epoxy resin and (meth)acrylate to increase the crosslinking density and accordingly improve the heat resistance. However, if a large quantity of double bonds are introduced, the dimensions stability becomes inferior due to curing shrinkage attributed to free volume decrease at the time of curing and also the cured coating film becomes brittle due to the increase of the crosslinking density, so that it could be difficult for the epoxy (meth)acrylate type photosensitive resin to improve the dimensions stability and lower the brittleness and simultaneously keep heat resistance.

On the other hand, use of polymers containing an N-substituted maleimide group and an ethylenic unsaturated double bond as a photosensitive resin satisfying the need of the high heat resistance has been investigated (e.g. Japanese Patent Application Laid-Open (JP-A) No. 10-139843 and JP-A No. 2002-62651).

However, in these systems, if the heat resistance is emphasized too much, cured materials of them tend to exhibit brittleness and furthermore their production takes a long time.

Therefore, the inventors of the invention made investigations and found a photosensitive resin for image formation that contain a polymer having an N-substituted maleimide component as a main component and gives a cured material excellent in heat resistance and scarcely exhibiting brittleness and already applied for patent (JP-A No. 2005-141011)

### SUMMARY OF THE INVENTION

However, the properties required become more and more challenging without a limit and further improvements have been requested continuously. Therefore, the purpose of the invention is to provide a photosensitive resin composition for image formation that satisfies photosensitivity at the time of exposure and alkali developability and that also gives a cured material keeping good heat resistance, excellent in dimensions stability, and exhibiting no brittleness.

The invention solving the above-mentioned problems provides a photosensitive resin composition containing a polymer (A) having an N-substituted maleimide group, a carboxyl group, and an ethylenic unsaturated double bond at a ratio less than 0.05 moles per 100 parts by mass of the polymer (A).

The photosensitive resin composition of the invention can satisfy both of the photosensitivity at the time of exposure and alkali developability and since it contains as a resin component a polymer which gives a cured material having excellent in dimensions stability and scarcely showing brittleness while keeping high heat resistance, the cured material is provided with excellent physical properties. Accordingly, the photosensitive resin composition of the invention is preferably usable as an alkali developable photosensitive resin composition for image formation for various kinds of applications for solder resist for printed circuit substrates, etching resist, electroless plating resist, an insulating layer for printed circuit substrates to be manufactured by build-up method, liquid crystal display fabrication, printing plate production and the like.

### DESCRIPTION OF THE PREFERRED EXAMPLES

Hereinafter, the invention will be described more in detail. A polymer (A) composing a photosensitive resin composition of the invention is a polymer having an N-substituted maleimide group, a carboxyl group, and an ethylenic unsaturated double bond at a ratio less than 0.05 mole per 100 parts by mass of the polymer (A).

A method of obtaining the polymer (A) may include (a) a method involving adding an unsaturated monobasic acid such as (meth)acrylic acid or its halide to a copolymer obtained using monomer components comprising an N-substituted maleimide compound and an epoxy group-containing ethylenic unsaturated compound, and successively causing reaction of a polybasic acid anhydride to the hydroxyl group formed by ring-opening of the epoxy group; (b) a method involving causing reaction of an epoxy group-containing ethylenic unsaturated compound with a copolymer obtained using monomer components comprising an N-substituted maleimide compound and an unsaturated monobasic acid such as (meth)acrylic acid; (c) a method involving introducing a carboxyl group by reaction of a polybasic acid anhydride to the hydroxyl group of a hydroxyl group-containing copolymer obtained using monomer components comprising an N-substituted maleimide compound and a hydroxyl group-containing ethylenic unsaturated compound such as 2-hydroxyethyl (meth)acrylate and successively causing reaction of an epoxy group-containing ethylenic unsaturated compound with the carboxyl group; (d) a method involving reaction of an unsaturated monobasic acid such as (meth)acrylic acid or its halide as well as a polybasic acid anhydride with the hydroxyl group of a hydroxyl group-containing copolymer obtained using monomer components comprising an N-substituted maleimide compound and a hydroxyl group-containing ethylenic unsaturated compound such as 2-hydroxyethyl (meth)acrylate; and (e) a method involving causing reaction of a hydroxyl group-containing ethylenic unsaturated compound such as 2-hydroxyethyl (meth)acrylate with a copolymer obtained using monomer components comprising an N-substituted maleimide compound and an unsaturated monobasic acid such as (meth)acrylic acid or its halide. Further, in place of the epoxy group-containing ethylenic unsaturated compound, an ethylenic unsaturated compound having a functional group reactive on a carboxyl group such as oxazolinyl group and oxetanyl group may be used.

Examples usable as the N-substituted maleimide compound in the invention are N-phenylmaleimide, N-(2-methylphenyl)maleimide, N-(4-methylphenyl)maleimide, N-(2,6-diethylphenyl)maleimide, N-(2-chlorophenyl)maleimide, N-methylmaleimide, N-ethylmaleimide, N-isopropylmaleimide, N-laurylmaleimide, N-cyclohexylmaleimide, N-phenylmethylmaleimide, N-(2,4,6-tribromophenyl)maleimide, N-[3-(triethoxysilyl)propyl)maleimide, N-octadecenylmaleimide, N-decenylmaleimide, N-(2-methoxyphenyl)maleimide, N-(2,4,6-trichlorophenyl)maleimide, and N-(4-hydroxyphenyl)maleimide. These compounds may be used alone or two or more of them may be used in combination. Among them, N-phenylmaleimide, N-(2-methylphenyl)maleimide, N-(2,6-diethylphenyl)maleimide, N-laurylmaleimide, and N-cyclohexylmaleimide are preferable, N-phenylmaleimide and N-cyclohexylmaleimide are more preferable, and N-phenylmaleimide is most preferable. Since the heat resistance improvement effect of them is big, they have excellent copolymerizability, and availability.

Examples usable as the epoxy group-containing ethylenic unsaturated compound in the case of employing one of the above-mentioned synthesis methods (a), (b), and (c) are aliphatic epoxy compounds such as glycidyl (meth)acrylate, allyl glycidyl ether, and 4-hydroxybutyl acrylate glycidyl ether and alicyclic epoxy compounds such as 3,4-epoxycyclohexylmethyl (meth)acrylate.

Examples usable as the unsaturated monobasic acid or its halide in the case of employing one of the above-mentioned synthesis methods (a), (b), (d), and (e) are monobasic acids each having one carboxyl group and one or more ethylenic unsaturated double bonds and their halides and practical examples are (meth)acrylic acid, crotonic acid, cinnamic acid, β-acryloxypropionic acid, and reaction products of hydroxyl group-containing ethylenic unsaturated compounds with polybasic acid anhydrides and halides of them.

To exhibit excellent alkali developability even in the presence of a hydrophobic group such as N-substituted maleimide group in the invention, it is preferable to introduce the carboxyl group at position apart from the main chain. Accordingly, in the case of using an unsaturated monobasic acid as a monomer component just like the methods of (b) and (e), it is preferable to use β-acryloxypropionic acid in which the carboxyl group and the ethylenic unsaturated double bond are bonded through one or more ester bonds or a reaction product of hydroxyl group-containing ethylenic unsaturated compound with a polybasic acid anhydride.

Examples of the polybasic acid anhydride to be used in the above-mentioned synthesis methods (a) to (e) are dibasic acid anhydride such as phthalic anhydride, succinic anhydride, octenylsuccinic anhydride, pentadodecenylsuccinic anhydride, maleic anhydride, tetrahydrophthalic anhydride, hexahydrophthalic anhydride, methyltetrahydrophthalic anhydride, 3,6-endomethylenetetrahydrophthalic anhydride, methylendomethylenetetrahydrophthalic anhydride, tetrabromophthalic anhydride, and reaction products of itaconic anhydride or maleic anhydride with 9,10-dihydro-9-oxa-10-phosphaphenanthrene-10-oxide; trimellitic anhydride; and aliphatic or aromatic tetrabasic acid dianhydride such as biphenyltetracarboxylic acid dianhydride, naphthalenetetracarboxylic acid dianhydride, diphenyl ether tetracarboxylic acid dianhydride, butanetetracarboxylic acid dianhydride, cyclopentanetetracarboxylic acid dianhydride, pyromellitic acid anhydride, and benzophenonetetracarboxylic acid dianhydride.

Examples of the hydroxyl group-containing ethylenic unsaturated compound to be used in the above-mentioned synthesis methods (b), (c), (d), and (e) are hydroxyalkyl vinyl ethers such as 2-hydroxyethyl (meth)acrylate, 3-hydroxypropyl (meth)acrylate, 2-hydroxypropyl (meth)acrylate, 4-hydroxybutyl (meth)acrylate, N-hydroxymethyl (meth)acrylamide, pentaerythritol mono(meth)acrylate, dipentaerythritol mono(meth)acrylate, trimethylolpropane mono(meth)acrylate, 1,6-hexanediol mono(meth)acrylate, glycerol mono(meth)acrylate, and 4-hydroxybutyl vinyl ether; allyl alcohol, and p-hydroxystyrene. Among them, those having primary alcohol type hydroxyl and those having secondary alcohol type hydroxyl and methyl or ethyl bonded to the carbon atom at α-position in relation to the hydroxyl are preferable and 2-hydroxyethyl (meth)acrylate, 2-hydroxypropyl (meth)acrylate, and 3-hydroxypropyl (meth)acrylate are particularly preferable, since they have excellent reactivity with a polybasic acid anhydride and efficient developability, and the generated carboxyl group is hard to catch steric barrier. Further, those which are obtained by adding alkylene oxide to the above-mentioned hydroxyl group-containing ethylenic unsaturated compounds; Placcel® F series (manufactured by Daicel Chem. Ind., Ltd.) which are polycaprolactone-modified products of 2-hydroxyethyl (meth)acrylate; and long chain alcohols which are reaction products of long chain dibasic acids such as 1,18-octadecanedicarboxylic acid and 1,16-(6-ethylhexadecane)dicarboxylic acid with epoxy group-containing monomers such as glycidyl (meth)acrylate are preferable for coating films having flexibility since they can provide such flexibility to cured coating films.

As a method for obtaining the polymer (A) may be employed any of the above-mentioned synthesis methods (a) to (e). Particularly, it is preferable to employ the method (b) or (e) which uses β-acryloxypropionic acid having a carboxyl group and an ethylenic unsaturated group bonded through one or more ester bonds as a monomer component and a reaction product of a hydroxyl group-containing ethylenic unsaturated compound with a polybasic acid anhydride, and the methods (c) and (d). It is because the carboxyl group can be introduced at a position apart from the polymer main chain through one or more ester bonds by these methods. As a result, the mobility of the carboxyl group is improved and even if a hydrophobic group such as the N-substituted maleimide group exists in the polymer, good alkali developability can be obtained. On the other hand, those obtained by copolymerization of (meth)acrylic acid as an unsaturated monobasic acid in the method (b) or (e) have the carboxyl group close to the main chain, so that the effect of the carboxyl group cannot be caused efficiently. Those obtained by reaction of a polybasic acid anhydride with the hydroxyl group formed by ring opening of the epoxy group in the method (a) also have the carboxyl group existing at a position in vicinity of the introduced ethylenic unsaturated bond, so that the mobility of the carboxyl group after photo (or thermal) polymerization may be decreased. From these facts, methods using β-acryloxypropionic acid or a reaction product of the hydroxyl group-containing unsaturated compound with the polybasic acid anhydride as a monomer component in the methods (b) and (e), and the methods of (c) and (d) are preferable to be employed in the invention. The method using the reaction product of the hydroxyl group-containing ethylenic unsaturated compound with the polybasic acid anhydride as a monomer component in the method (b), and the method of (c) are particularly preferable.

In the invention, examples to be used as another monomer component usable in the case of producing the polymer (A) are aromatic vinyl monomers such as styrene, α-methylstyrene, α-chlorostyrene, and vinyltoluene; vinyl ester monomers such as vinyl acetate and vinyl adipate; (meth)acrylate monomers such as methyl (meth)acrylate, ethyl (meth)acrylate, butyl (meth)acrylate, cyclohexyl (meth)acrylate, n-dodecyl (meth)acrylate, 2-ethylhexyl (meth)acrylate, n-hexyl (meth)acrylate, and stearyl (meth)acrylate; alkyl vinyl ethers such as n-propyl vinyl ether, isopropyl vinyl ether, n-butyl vinyl ether, isobutyl vinyl ether, n-hexyl vinyl ether, cyclohexyl vinyl ether, 2-ethylhexyl vinyl ether and alkyl vinyl (thio)ethers corresponding to these alkyl vinyl ethers; and N-vinyl monomers such as N-vinylpyrrolidone and N-vinyloxazolidone. Among them are aromatic vinyl monomers (particularly styrene) preferable since they are excellent in copolymerization with the N-substituted maleimide compound, excellent in electric properties, and economical.

As described above, a method for obtaining the polymer (A) in the invention is most preferably the method (b) in which the reaction product of the hydroxyl group-containing ethylenic unsaturated compound and the polybasic acid anhydride as a monomer component and the method (c) and hereinafter those methods will be described more in detail.

In the method (b), to obtain the reaction product of the hydroxyl group-containing ethylenic unsaturated compound and the polybasic acid anhydride, a conventionally known method can be employed. More practically, the respective compounds are charged in proper amounts to make the hydroxyl group and the acid anhydride group equimolecular and subjected to reaction, if necessary, in the presence of a catalyst and a solvent at a reaction temperature preferably 60 to 150° C., more preferably 80 to 130° C. Practically usable catalysts are tertiary amines such as triethylamine; quaternary ammonium salts such as triethylbenzylammonium chloride; imidazole compounds such as 2-ethyl-4-methylimidazole; phosphorus compounds such as triphenylphosphine and tetraphenylphosphonium bromide; carboxylic acid metal salts such as lithium acetate; inorganic metal salts such as lithium carbonate. A solvent to be used may be properly selected from solvents usable for the solution polymerization described below.

A method of obtaining a copolymer comprising the N-substituted maleimide compound and the unsaturated monobasic acid obtained by the hydroxyl group-containing ethylenic unsaturated compound and the polybasic acid anhydride as monomer components in the method (b) or a method of obtaining a copolymer comprising the N-substituted maleimide compound and the hydroxyl group-containing ethylenic unsaturated compound as monomer components in the method (c) is not particularly limited and conventionally known polymerization methods such as a solution polymerization method and a bulk polymerization method may be employed. Among them, a solution polymerization method easy to control the temperature during the reaction is preferable.

In the case, the above-mentioned copolymer consists of 100% by mole of the constituent units, it is preferable that the amount of the N-substituted maleimide group-containing constituent unit is adjusted to be 15 to 60% by mole. This preferable range is the same as that of the N-substituted maleimide group-containing unit in the polymer (A). If the amount of the N-substituted maleimide group-containing unit is less than 15% by mole, it becomes impossible to provide sufficient heat resistance to a cured coating film. On the other hand, if the amount of the N-substituted maleimide group-containing unit is more than 60% by mole, the amount of the carboxyl group derived from the unsaturated monobasic acid in the method (b) and the amount of the unit derived from the hydroxyl group-containing ethylenic unsaturated compound in the method (c) are decreased and therefore the amount of the carboxyl group to be introduced successively in the polybasic acid anhydride reaction may become insufficient to exhibit the alkali developability in some cases. The amount of the N-substituted maleimide group-containing unit is more preferably 20% by mole and even more preferably 25% by mole in the lower limit. The amount is more preferably 50% by mole and even more preferably 40% by mole in the upper limit.

A solvent to be used in the solution polymerization is not particularly limited if it may not hinder the polymerization or deform the respective starting monomer components. Practical examples of usable solvents are hydrocarbons such as toluene and xylene; esters such as cellosolve acetate, carbitol acetate, (di)propylene glycol monomethyl ether acetate, (di)methyl glutarate, (di)methyl succinate, (di)methyl adipate, methyl acetate, ethyl acetate, butyl acetate, and methyl propionate; ketones such as acetone, methyl ethyl ketone, and methyl isobutyl ketone; ethers such as diethyl ether, diisopropyl ether, tetrahydrofuran, 1,4-dioxane, methyl tert-butyl ether, and (di)ethylene glycol dimethyl ether; amides such as N,N-dimethylacetamide; and sulfoxides such as dimethyl sulfoxide and they may be used alone or two or more of them may be used in form of a mixture.

An initiator usable for the polymerization reaction may be common radical polymerization initiators. Practical examples are azo type compounds such as 2,2′-azobisisobutyronitrile, 2,2′-azobis(4-methoxy-2,4-dimethylvaleronitrile), 2,2′-azobis(2,4-dimethylvaleronitrile), and 2,2′-azobis(2-methylisobutyronitrile); and organic peroxides such as lauroyl peroxide, benzoyl peroxide, tert-butyl peroxyneodecanate, tert-butyl peroxypivalate, tert-butyl peroxy-2-ethylhexanoate, tert-butyl peroxybenzoate, methyl ethyl ketone peroxide, and dicumyl peroxide and the polymerization initiator may be properly selected in accordance with the desired reaction conditions. The use amount of the polymerization initiator is in a range preferably from 0.01 to 15% by mass and more preferably from 0.1 to 10% by mass to the N-substituted maleimide compound (A) to be used for the polymerization reaction.

A practical manner of the solution polymerization method is not particularly limited, however it may be that all of the components are added in a solvent together to carry out polymerization or that some of the solvent and components are charged to a reaction vessel and then the remaining components are continuously or intermittently added to the vessel to carry out polymerization. The pressure at the time of reaction is also not particularly limited and the reaction may be carried out in any pressure condition, e.g. normal pressure condition or pressurized condition. Although it depends on the kinds and the composition ratios of the starting monomer components to be employed and the kinds of the solvent to be used, the temperature at the time of polymerization reaction is generally in a range preferably from 20 to 150° C. and more preferably from 30 to 130° C.

At the time of polymerization reaction, it is preferable to set the amounts of the solvent and the respective monomer components in a manner that the final solid concentration of the polymerization solution is controlled to be in a range from 10 to 70% by mass. If the final solid concentration is less than 10% by mass, the productivity becomes low and therefore it is not preferable. On the other hand, if the final solid concentration exceeds 70% by mass, even in the case of solution polymerization, the viscosity of the polymerization solution increases and accordingly the polymerization conversion ratio may not be increased. The final solid concentration is more preferably in a range from 20 to 65% by mass and even more preferably in a range from 30 to 60% by mass.

In consideration of the properties of the resin composition, the alkali developability, the physical properties of a cured coating film, and the heat resistance, the weight average molecular weight Mw of the copolymer is preferably in a range from 1,000 to 200,000 on the basis of polystyrene conversion value measured by gel permeation chromatography (GPC) (the measurement condition will be described more in detail later). If Mw is less than 1,000, the tack-free property at the time of coating film formation by heat drying and the heat resistance of the cured coating film may possibly become insufficient. On the other hand, if Mw exceeds 200,000, the alkali developability may be possibly decreased. The lower limit of Mw is more preferably 3,000 and even more preferably 5,000. The upper limit of Mw is more preferably 150,000 and even more preferably 100,000.

To adjust the molecular weight in the range, if necessary, a chain transfer agent may be used at the time of the polymerization reaction. A usable chain transfer agent is not particularly limited if it does not cause any adverse effect on the respective monomer components to be used for the polymerization and generally a thiol compound may be used. Practical examples to be used preferably are alkyl mercaptans such as n-octyl mercaptan, n-dodecyl mercaptan, and tert-dodecyl mercaptan; aryl mercaptans such as thiophenol; and mercapto group-containing aliphatic carboxylic acids and their esters such as mercaptopropionic acid and methyl mercaptopropionate. The use amount of the chain transfer agent is not particularly limited and may be so properly adjusted as to obtain a copolymer having a desired molecular weight and generally it is in a range from 0.001 to 1.0 (by mole ratio) to the total mole of the monomers to be used for the polymerization.

In the method (c), successively reaction of the polybasic acid anhydride on the hydroxyl groups in the copolymer is carried out. The polybasic acid anhydride is reacted in a manner that the acid anhydride group of the polybasic acid anhydride is adjusted to be in an amount preferably from 0.1 to 1.1 mole and more preferably 0.2 to 1.0 mole to the 1 chemical equivalent to the hydroxyl group in the copolymer.

The solvent at the time of the reaction is not particularly limited and the above-mentioned solvents exemplified as the solvent to be used for the polymerization solvent are all usable. Industrially, it is convenient to carry out modification reaction by adding the polybasic acid anhydride to the reaction solution successively to the solution polymerization. With respect to the reaction conditions, the conventionally known techniques employed at the time of obtaining the reaction product of the hydroxyl group-containing ethylenic unsaturated compound and the polybasic acid anhydride can be employed also in the method (b).

The synthesis method (a typical example) of the copolymer having the N-substituted maleimide group and the carboxyl group bonded to the main chain through one or more ester bonds is described above. In the above explanation and the explanation below, the term, “copolymer” means a copolymer before modification into the polymer (A) in the following step.

Next, reaction of an ethylenic unsaturated compound having a functional group reactive on a carboxyl group with the carboxyl group of the copolymer to obtain the polymer (A) will be described.

The functional group reactive on the carboxyl group may include an epoxy group, a vinyl ether group, an oxazolinyl group, an aziridinyl group, and an oxetanyl group. Practical examples of the ethylenic unsaturated compound having the functional group reactive on the carboxyl group are the above-mentioned epoxy group-containing ethylenic unsaturated compound, 2-(vinyloxyethoxy)ethyl (meth)acrylate, 2-isopropenyl-2-oxazoline, N-(meth)acryloylaziridine, and 3-(meth)acryloxymethyloxetane and one or more of these compounds may be used.

In the case the copolymer has a hydroxyl group, an ethylenic unsaturated compound having a functional group reactive on the hydroxyl group is reacted with the copolymer to introduce the ethylenic unsaturated double bond into the polymer (A). The functional group reactive on the hydroxyl group may be an isocyanato group and a vinyl ether group. Practical examples of the ethylenic unsaturated compound having the functional group reactive on the hydroxyl group are isocyanatoethyl (meth)acrylate and 2-(vinyloxyethoxy)ethyl (meth)acrylate and the like, and one or more of these compounds may be used.

In the method (c), in the case reaction of the hydroxyl group of the copolymer and the ethylenic unsaturated compound having a functional group reactive on the hydroxyl group is carried out, the reaction may be carried out in any step, e.g. before or after the reaction with the polybasic acid anhydride, simultaneously with the reaction, and the like. The ethylenic unsaturated double bond introduction reaction may be carried out by a conventionally known method while the catalyst and the reaction temperature are properly selected for the respective functional groups.

The ethylenic unsaturated compound to be reacted on the carboxyl group and/or hydroxyl group in the copolymer is adjusted in a manner that the amount of the ethylenic unsaturated double bond is less than 0.05 mole in 100 parts by mass of the polymer (A) to be obtained. Practically, it is preferable to control the functional group of the ethylenic unsaturated compound reactive on these groups is 0.9 mole or less, more preferably 0.8 mole or less. If the mole of the ethylenic unsaturated double bond in 100 parts by mass of the polymer (A) is 0.05 mole or more, the cured coating film may become brittle or the bond strength to a substrate may be lowered due to the volume shrinkage at the time of curing (the dimensions stability is decreased) and thus the physical properties become unbalance. The upper limit is more preferably 0.048 moles.

The photosensitive resin composition of the invention is possible to be subjected to alkali development since the polymer (A) of the composition has the carboxyl group. To exhibit better alkali developability even in an aqueous weakly alkaline solution, it is desirable to adjust the monomer composition and the use amount of the ethylenic unsaturated compound at the time of polymerization so that the acid value of the polymer (A) is 30 mgKOH/g or larger (more preferably 50 mgKOH/g or larger) and 150 mgKOH/g or smaller (more preferably 120 mgKOH/g or smaller).

Since the polymer (A) obtained in the above-mentioned manner has both of the carboxyl group and the ethylenic unsaturated bond, the polymer (A) by itself can be used as an alkali developable photosensitive resin for image formation. Further, the polymer (A) may be used in form of an alkali developable photosensitive resin composition for image formation while being mixed with an ethylenic unsaturated compound (B).

The ethylenic unsaturated compound (B) may be a radical polymerizable resin and a radical polymerizable monomer.

Examples usable as the radical polymerizable resin are unsaturated polyesters, epoxy (meth)acrylate, urethane (meth)acrylate, and polyester (meth)acrylate and the like.

In the case the radical polymerizable resin is used as the ethylenic unsaturated compound (B), to efficiently cause the heat resistance improvement effect attributed to the polymer (A) of the photosensitive resin composition of the invention, the radical polymerizable resin is preferably used in an amount of 300 parts by mass or less to 100 parts by mass of the polymer (A) of the invention. The upper limit is more preferably 200 parts by mass and even more preferably 150 parts by mass.

Since the epoxy (meth)acrylate among the above exemplified radical polymerizable resins is particularly excellent in the photo-polymerizability and effective to improve the properties of a cured material to be obtained, it is preferably used as the photosensitive resin component in the photosensitive resin composition of the invention. As the epoxy (meth)acrylate is used a reaction product of a conventionally know epoxy resin having two or more epoxy groups in one molecule and an unsaturated monobasic acid (e.g. (meth)acrylic acid) as it is.

The epoxy resin is preferably an epoxy resin having three or more epoxy groups in one molecule and more preferably a novolak type epoxy resin and if a novolak type epoxy resin having a softening point of 75° C. or higher is used, the tack-free property at the time of coating film formation by heat drying is made better and it is particularly preferable. Further, it is also possible to use, as the epoxy (meth)acrylate, a carboxyl group-containing epoxy (meth)acrylate obtained by addition reaction of the above-mentioned polybasic acid anhydride to the hydroxyl group of the epoxy (meth)acrylate and it results in attainment of high alkali developability.

The reaction of the epoxy (meth)acrylate with the polybasic acid anhydride can be carried out in the same manner as the above-mentioned reaction of the hydroxyl group and the polybasic acid anhydride. In the case the method (c) is employed as a method of obtaining the polymer (A), the polybasic acid anhydride is added to a mixture of the copolymer before reaction with the polybasic acid anhydride and the epoxy (meth)acrylate to carry out reaction and the reaction for introducing the carboxyl group into the polymer (A) can be simultaneously carried out.

A radical polymerizable monomer is also usable as the ethylenic unsaturated compound (B) and both of a monofunctional monomer (one radical polymerizable double bond) and a polyfunctional monomer (two or more radical polymerizable double bonds) are usable. The radical polymerizable monomer is relevant to the photopolymerization and improves the properties of the cured material to be obtained and adjusts the viscosity of the photosensitive resin composition as well. The use amount in the case of using the radical polymerizable monomer is preferably 300 parts by mass or less (more preferably 100 parts by mass or less) to 100 parts by mass of the total of the polymer (A) of the invention and the radical polymerizable resin.

Practical examples of the radical polymerizable monomer are the N-substituted maleimide compound, the hydroxyl group-containing ethylenic unsaturated compound, the unsaturated monobasic acid such as (meth)acrylic acid, the ethylenic unsaturated compound having the functional group such as the epoxy group reactive on the carboxyl group, which are starting materials to obtain the polymer (A), and monomers exemplified above as the monomers (monofunctional monomers) to be used in combination and also aromatic vinyl monomers such as divinylbenzene, diallyl phthalate, and diallylbenzene phosphonate; (meth)acrylic monomers such as (di)ethylene glycol di(meth)acrylate, propylene glycol di(meth)acrylate, trimethylolpropane di(meth)acrylate, trimethylolpropane tri(meth)acrylate, pentaerythritol tetra(meth)acrylate, dipentaerythritol hexa(meth)acrylate, and tris[2-(meth)acryloyloxyethyl]triazine; vinyl (thio)ether compounds having ethylenic unsaturated double bond such as 2-(vinyloxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, and 2-(isopropenoxyethoxyethoxyethoxyethoxy)ethyl (meth)acrylate; and polyfunctional monomers having two or more radical polymerizable double bonds such as triallyl cyanurate. These monomers may be selected properly in accordance with the uses and the required properties of the photosensitive resin composition and one or more of them may be used in form of a mixture.

The ethylenic unsaturated compound (B) is preferable to be added in an amount proper to adjust the total mole of the ethylenic unsaturated double bond in the polymer (A) and the ethylenic unsaturated compound (B) in a range from 0.03 to 0.3 mole per 100 parts by mass of the total of the polymer (A) and the ethylenic unsaturated compound (B). If the total mole of the ethylenic unsaturated double bond exceeds 0.3 mole, the cured coating film may become brittle and the bond strength to a substrate is decreased due to the volume shrinkage at the time of curing (dimensions stability is deteriorated) and thus the physical properties may be in unbalance. The upper limit is more preferably 0.25 moles and even more preferably 0.2 moles. On the other hand, if it is less than 0.03 moles, no sufficient heat resistance can be obtained. The lower limit is more preferably 0.05 moles and even more preferably 0.07 moles.

In terms of the workability at the time of applying the photosensitive resin composition of the invention to a substrate, a solvent may be added to the composition. As the solvent, those usable for obtaining the polymer by a solution polymerization method can be used and one or more of solvents may be used in form of a mixture and a proper amount to adjust the viscosity of the composition to be optimum at the time of application work.

The photosensitive resin composition of the invention can be thermally cured by using a conventionally known heat polymerization initiator, however in the case of carrying out fine processing or image formation by photolithography, it is preferable to carry out photocuring by adding a photo-polymerization initiator.

Conventionally usable initiators may be used as the photo-polymerization initiator and examples are benzoines and their alkyl ethers such as benzoine, benzoine methyl ether, and benzoine ethyl ether; acetophenones such as acetophenone, 2,2-dimethoxy-2-phenylacetophenone, 1,1-dichloroacetophenone, and 4-(1-tert-butyldioxy-1-methylethyl) acetophenone; anthraquinones such as 2-methylanthraquinone, 2-amylanthraquinone, 2-tert-butylanthraquinone, and 1-chloroanthraquinone; thioxanthones such as 2,4-dimethylthioxanthone, 2,4-diisopropylthioxanthone, and 2-chlorothioxanthone; ketals such as acetophenonedimethyl ketal and benzyldimethyl ketal; benzophenones such as benzophenone, 4-(1-tert-butyldioxy-1-methylethyl)benzophenone, and 3,3′,4,4′-tetrakis(tert-butyldioxycarbonyl)benzophenone; 2-methyl-1-[4-(methylthio)phenyl]-2-morpholino-propan-1-one and 2-benzyl-2-dimethylamino-1-(4-morpholinophenyl)-butan-1-one; acylphosphine oxides, and xanthones.

These photopolymerization initiators may be used alone or two or more of them may be used in form of a mixture. It is preferable for the initiator to be added in an amount of 0.5 to 30 parts by mass to 100 parts by mass of the total of the polymer (A) and the ethylenic unsaturated compound (B). If the amount of the photopolymerization initiator is less than 0.5 parts by mass, the light radiation time has to be prolonged or polymerization becomes difficult to start even by radiating light to result in impossibility of obtaining proper surface hardness. Additionally, even if the photopolymerization initiator is added in an amount exceeding 30 parts by mass, no advantageous effect for the use in a large quantity is caused.

The photosensitive resin composition of the invention may contain a compound (C) having two or more functional groups reactive on a carboxyl group in one molecule. The compound (C) is a crosslinking agent for carrying out crosslinking reaction of the carboxyl groups in the polymer (A). If the compound (C) is added, three-dimensional curing reaction can be caused by combination of light and heat to give a more firmly cured coating film. In the case of using the composition for image formation, heat treatment may be carried out after light radiation and alkali development to consume the carboxyl groups in the cured coating film and increase crosslinking degree and accordingly the physical properties such as durability can be improved further.

Examples to be used as the above-mentioned compound (C) are an epoxy compound, an oxazoline compound, and an oxetane compound. Practical examples are as the epoxy compound, a novolak type epoxy resin, a bisphenol type epoxy resin, a biphenyl type epoxy resin, an alicyclic epoxy resin, and triglycidyl isocyanurate; as the oxazoline compound, 1,3-phenylenebisoxazoline; and as the oxetane compound, 1,4-bis[3-(3-ethyloxetanyl)methoxy]benzene.

The use amount of the compound (C) is preferably 5 to 70 parts by mass and more preferably 10 to 60 parts by mass to 100 parts by mass in total of the polymer (A) and the ethylenic unsaturated compound (B). In this case, a curing agent such as a dicyandiamide and an imidazole compound may be used in combination.

The photosensitive resin composition of the invention may further contain, based on the necessity, a filler such as talc, clay, and barium sulfate; and conventionally known additives such as a pigment for coloration, a defoaming agent, a coupling agent, a leveling agent, a sensitizer, a release agent, a lubricant, a plasticizer, an antioxidant, a ultraviolet absorbent, a flame retarder, a polymerization suppresser, and a thickener. Further, various kinds of reinforcing fibers may be used as fibers for reinforcement to give a fiber-reinforced composite material.

In the case the photosensitive resin composition of the invention is used for image formation, generally the composition is applied to a substrate, dried, and exposed by a conventionally known method to obtain a cured coating film and successively the unexposed parts are dissolved in an aqueous alkaline solution to carry out alkali development. Practical examples of the alkali usable for the development are alkali metal compounds such as sodium carbonate, potassium carbonate, sodium hydroxide, and potassium hydroxide; alkaline earth metal compounds such as calcium hydroxide; ammonia; and water-soluble organic amines such as monomethylamine, dimethylamine, trimethylamine, monoethylamine, diethylamine, triethylamine, monopropylamine, dimethylpropylamine, monoethanol amine, diethanol amine, triethanol amine, ethylenediamine, diethylenetriamine, dimethylaminoethyl methacrylate, and polyethylene imine and one or more of them may be used.

The photosensitive resin composition of the invention may be used in form of a dry film obtained by previously applying the composition to a film of such as polyethylene terephthalate and drying the composition other than the method of applying the composition in liquid phase directly to a substrate. In this case, the dry film is laminated to a substrate and may be separated before or after exposure.

Further, it is also possible to employ a method of drawing an image using a CTP (Computer To Plate) system that have been employed frequently in printing plate production fields in these years, that is, a method involving directly scanning and exposing a coating film with laser beam according to digital data without using a film for pattern formation at the time of exposure.

### EXAMPLES

Hereinafter, the invention will be described more in detail with reference to Examples, it is not intended that the invention be limited to the following illustrated Examples. All modifications without departing from the spirit of the invention can be made and fall within the technical scope of the invention. In addition, unless otherwise specified, the terms, “part” and “%” mean “part by mass” and “% by mass”, respectively. Further, the measurement methods of the various physical properties in the following Examples are as follows.

Developability

Irgacure®907 (a photopolymerization initiator manufactured by Ciba Specialty Chemicals Corp.) in an amount of 5% on the basis of solid matter was added to a mixture of a solution of the polymer (A) and a solution of the ethylenic unsaturated compound (B) to obtain an even solution and the solution was applied in a proper amount to give 50 μm film thickness in dry state to a copper plate and heated at 80° C. for 30 minutes. After that, the resulting copper plate was immersed in an aqueous 1% sodium carbonate solution at 30° C. to evaluate the developability (alkali solubility). If the coating film was dissolved within 60 seconds, ◯ was marked and if the coating film remained even after 60 second, X was marked.

Photo-Curability

After exposure to the dried coating film obtained in the same manner as that in the developability evaluation was carried out at 2 J/cm² dose using a ultraviolet exposure apparatus, the coating film was immersed in an aqueous 1% sodium carbonate solution at 30° C. for 90 seconds and the photo-curability was evaluated based on the remaining degree of the coating film. If the coating film was not affected, ◯ was marked and if the coating film was peeled, X was marked.

Heat Resistance: Glass Transition Temperature

A cresol novolak type epoxy resin (trade name: EOCN-104S, epoxy equivalent 219, manufactured by Nippon Kayaku Co., Ltd.) as the compound (C) in an amount of 40%, Irgacure® 907 in an amount of 5%, and dicyandiamide as a curing agent in an amount of 2% on the basis of solid matter were added to a mixture of a solution of the polymer (A) and a solution of the ethylenic unsaturated compound (B) to obtain an even solution and the solution was applied in a proper amount to give 100 μm film thickness in dry state to a polyethylene terephthalate film and heated at 80° C. for 30 minutes. Further, after exposure at 2 J/Cm² dose using an ultraviolet exposure apparatus was carried out, the film was further heated at 160° C. for 1 hour. After cooled to a room temperature, the cured coating film was separated from the polyethylene terephthalate film to obtain a specimen. The heat resistance was measured on the basis of glass transition temperature (Tg: ° C.) by TMA (TMA-50 was used; manufactured by Shimadzu Corp.). The specimen for TMA measurement was formed in a rectangular form of about 20 mm vertical size and about 5 mm transverse size and Tg was measured while the specimen was pulled in the vertical direction and the heating rate was controlled at 5° C./min from 23° C. to 200° C.

Flexibility

A specimen obtained in the manner as the specimen for TMA measurement was used for the evaluation of flexibility using 10 mmφ stick according to JIS K 5400⁻¹⁹⁹⁰ of 8.1 at a room temperature (23° C.). The occurrence of cracking was observed with eyes. If no crack was formed, ◯ was marked and if the cracks were formed, x was marked. Further, in the case no crack was formed, another specimen was heated at 120° C. for 1 week and then the flexibility was evaluated at a room temperature (23° C.) in the same manner as described above.

Adhesiveness (Dimensions Stability)

After a dries coating film obtained in the same manner as that in the developability evaluation was exposed at 2 J/cm² dose using an ultraviolet exposure apparatus, the coating film was heated at 180° C. for 30 minutes as high temperature condition. After the coating film was cooled to a room temperature, a cellophane tape (product number: CT-24, manufactured by Nichiban Co., Ltd.) was stuck in an about 20 mm-square stuck face by hand and soon peeled by hand and the remaining state of the coating film was evaluated by eye observation. In the case the coating film was not affected, ◯ was marked, in the case the coating film was partially peeled, Δ was marked, and in the case almost all of the coating film was peeled, x was marked.

### Synthesis Example 1

(Synthesis of Polymer (A-1))

A vessel equipped with a stirrer, a thermometer, a refluxing condenser, a gas introduction tube, and a titration funnel was added 260 parts of DBE-5 (trade name, mainly dimethyl glutarate, manufactured by Du Pont de Nemours & Co.) as a solvent and after air in the vessel was replaced with nitrogen gas for 10 minutes, the solvent was heated to 110° C. while being stirred. Two other titration funnels were made ready and a solution obtained by mixing 113.1 parts of N-phenylmaleimide, 141.6 parts of 2-hydroxyethyl methacrylate, 45.3 parts of styrene, and 200 parts of DBE-5 as a solvent was put into one of the funnels. A solution obtained by mixing 6 parts of 2,2′-azobis(2-methylbutyronitrile) [V-59: manufactured by Wako Pure Chemical Industries, Ltd.] as a polymerization initiator and 60 parts of DBE-5 as a solvent was put into the other funnel.

The temperature in the vessel was kept at 110° C., under the atmosphere of nitrogen, the respective solutions in the two funnels were dropwise added for 2 hours to carry out polymerization and on completion of the dropwise addition, the reaction product was aged for further 3 hours at 110° C. On completion of the aging, the nitrogen gas introduction was switched to a gas mixture of nitrogen/air=1/1 (vol. %) and the inside temperature was heated to 120° C. and kept for 1 hour to inactivate the polymerization initiator.

The solution obtained as described contained 36.6% of a copolymer of N-phenylmaleimide:2-hydroxyethyl methacrylate:styrene=30:50:20 (mole ratio) having a weight average molecular weight (Mw) of 24000 on the basis of polystyrene conversion by gel permeation chromatography (GPC). The measurement conditions of GPC were as follows.

Measurement apparatus: HLC-8020 (manufactured by Tosoh Corporation)

Column: TSK gel G4000H×1, TSK gel G3000H×2, and TSK gel G2000H×1 connected in series (all manufactured by Tosoh Corporation)

Eluent: tetrahydrofuran

Eluent flow rate: 1 ml/min

Detector: RI

Next, carboxyl group introduction reaction was carried out. To the entire amount of the above-mentioned copolymer solution, 149 parts of tetrahydrophthalic anhydride and 0.24 parts of benzyltriethylammonium chloride as a catalyst were added and reaction was carried out at 120° C. for 4 hours in the atmosphere of a gas mixture of nitrogen/air=1/1 (vol. %). A solution containing 46.3% of a copolymer having an acid value of 122 mgKOH/g and having the introduced carboxyl group was obtained.

Next, ethylenic unsaturated double bond introduction reaction was carried out. To 100 parts of the solution containing the above-mentioned copolymer having the introduced carboxyl group, 3.17 parts of glycidyl methacrylate, 0.03 parts of methylhydroquinone as a polymerization inhibitor, and 0.02 parts of benzyltriethylammonium chloride as a catalyst were added and reaction was carried out at 110° C. for 6 hours in the atmosphere of a gas mixture of nitrogen/air=1/1 (vol. %). As a result, a DBE-5 solution containing 48.0% of a polymer (A-1), having an acid value of 89 mgKOH/g, and containing 0.045 mole of ethylenic unsaturated double bond per 100 parts by mass of the polymer was obtained.

### Synthesis Example 2

(Synthesis of Carboxyl Group-Containing Epoxy Acrylate as the Ethylenic Unsaturated Compound (B))

A vessel equipped with a stirrer, a thermometer, a refluxing condenser, and a gas introduction tube was added 414 parts of a cresol novolak type epoxy resin (trade name: YDCN-703, epoxy equivalent 207, manufactured by Tohto Kasei Co., Ltd.), 145 parts of acrylic acid, 314 parts of the above-mentioned DBE-5, 1.7 parts of benzyltriphenylphosphonium chloride as an esterification catalyst, and 0.5 parts of methylhydroquinone as a polymerization inhibitor and reaction was carried out at 120° C. for 20 hours in the atmosphere of a gas mixture of nitrogen/air=1/1 (vol. %) and it was confirmed that the acid value of the reaction product became 2 mgKOH/g. Next, 109 parts of tetrahydrophthalic anhydride and 0.3 parts of benzyltriethylammonium chloride as a catalyst were added and reaction was carried out at 100° C. for 2 hours in the atmosphere of a gas mixture of nitrogen/air=1/1 (vol. %) to obtain a DBE-5 solution containing 68.0% of an ethylenic unsaturated compound (B) and having an acid value of 62 mgKOH/g.

### Example 1

(Preparation of Photosensitive Resin Composition and Evaluation of Properties)

A resin composition obtained by mixing 10 parts of the above-mentioned solution containing the polymer (A-1) and 8.6 parts of the solution containing the ethylenic unsaturated compound (B) was subjected to the evaluations of developability, photo-curability, thermal properties, flexibility, and adhesiveness by the above-mentioned methods. The results are shown in Table 1.

### Synthesis Example 3

(Synthesis of Polymer (A-2))

Using 100 parts of the solution containing 46.3% of the copolymer having an acid value of 122 mgKOH/g and having the introduced carboxyl group, which was obtained in the middle of the synthesis of the polymer (A-1) in Synthesis Example 1, ethylenic unsaturated double bond introduction reaction by 4-hydroxybutyl acrylate glycidyl ether (manufactured by Nippon Kasei Chemical Co., Ltd.) was carried out.

Reaction was carried out in the same manner as Synthesis Example 1, except that 4.47 parts of 4-hydroxybutyl acrylate glycidyl ether was used in place of glycidyl methacrylate, 1.40 parts of DBE-5 was added at the time of adding, and reaction was carried out at 110° C. for 8 hours. A DBE-5 solution containing 48.0% of a polymer (A-2), having an acid value of 88 mgKOH/g, and containing 0.044 mole of ethylenic unsaturated double bond per 100 parts of the polymer was obtained.

### Example 2

(Preparation of Photosensitive Resin Composition and Evaluation of Properties)

A resin composition was obtained in the same manner as Example 1 except that the above-mentioned solution containing the polymer (A-2) was used in place of the solution containing the polymer (A-1) and subjected to the evaluations of respective properties. The results are shown in Table 1.

### Synthesis Example 4

(Synthesis of Polymer (A-3))

To the vessel same as that used in Synthesis Example 1, 276 parts of DBE-5 was added as a solvent and after air in the vessel was replaced with nitrogen gas for 10 minutes, the solvent was heated to 110° C. while being stirred. Two other titration funnels were made ready and a solution obtained by mixing 111 parts of N-phenylmaleimide, 166.8 parts of 2-hydroxyethyl methacrylate, 22.2 parts of styrene, and 216 parts of DBE-5 was added into one of the funnels. A solution obtained by mixing 6 parts of 1,1′-azobis (cyclohexane-1-carbonitrile) [V-40: manufactured by Wako Pure Chemical Industries, Ltd.] as a polymerization initiator and 60 parts of DBE-5 was added into the other funnel. Thereafter, polymerization was carried out in the same manner as Synthesis Example 1. A solution containing 35.2% of a copolymer of N-phenylmaleimide:2-hydroxyethyl methacrylate:styrene=30:60:10 (mole ratio) having Mw of 45000 was obtained.

Next, carboxyl group introduction reaction was carried out in the same manner as Synthesis Example 1 using the entire amount of the above-mentioned copolymer solution, 178.8 parts of tetrahydrophthalic anhydride, and 0.26 parts of benzyltriethylammonium chloride. A solution containing 46.4% of a copolymer having introduced carboxyl group with an acid value of 138 mgKOH/g was obtained.

Next, ethylenic unsaturated double bond introduction reaction was carried out in the same manner as Synthesis Example 1 using 100 parts of the above-mentioned copolymer solution, 2.92 parts of glycidyl methacrylate, 0.03 parts of methylhydroquinone, and 0.02 parts of benzyltriethyl ammonium chloride. As a result, a DBE-5 solution containing 48.0% of a polymer (A-3), having an acid value of 106 mgKOH/g, and containing 0.042 mole of ethylenic unsaturated double bond per 100 parts by mass of the polymer was obtained.

### Example 3

(Preparation of Photosensitive Resin Composition and Evaluation of Properties)

A resin composition was obtained in the same manner as Example 1 except that the above-mentioned solution containing the polymer (A-3) was used in place of the solution containing the polymer (A-1) and subjected to the evaluations of respective properties. The results are shown in Table 1.

### Synthesis Example 5

(Synthesis of Polymer (A-4))

To the vessel same as that used in Synthesis Example 1, 174.1 parts of DBE-5 was added as a solvent and after air in the vessel was replaced with nitrogen gas for 10 minutes, the solvent was heated to 110° C. while being stirred. A solution obtained by mixing 100 parts of N-phenylmaleimide, 260 parts of Light Acrylate HOA-HH (trade name, addition reaction product of 2-hydroxyethyl acrylate and hexahydrophthalic anhydride, manufactured by Kyoeisha Chemical Co., Ltd.), 40 parts of styrene, and 268.2 parts of DBE-5 was added into one funnel. A solution obtained by mixing 8 parts of above-mentioned V-59 and 80 parts of DBE-5 was added into the other funnel. Thereafter, polymerization was carried out in the same manner as Synthesis Example 1. A solution containing 43.4% of a copolymer of N-phenylmaleimide:HOA-HH:styrene=30:50:20 (mole ratio) having Mw of 15000 and the introduced carboxyl group with an acid value of 135 mgKOH/g was obtained.

Next, ethylenic unsaturated double bond introduction reaction was carried out in the same manner as Synthesis Example 1 using 100 parts of the above-mentioned copolymer solution, 2.94 parts of glycidyl methacrylate, 0.03 parts of methylhydroquinone, and 0.02 parts of benzyltriethyl ammonium chloride. As a result, a DBE-5 solution containing 45.0% of a polymer (A-4), having an acid value of 102 mgKOH/g, and containing 0.045 mole of ethylenic unsaturated double bond per 100 parts by mass of the polymer was obtained.

### Example 4

(Preparation of Photosensitive Resin Composition and Evaluation of Properties)

A resin composition was obtained in the same manner as Example 1 except that 10.7 parts of the above-mentioned solution containing the polymer (A-4) was used in place of the solution containing the polymer (A-1) and subjected to the evaluations of respective properties. The results are shown in Table 1.

### Example 5

(Preparation of Photosensitive Resin Composition and Evaluation of Properties)

A resin composition was obtained by mixing 38.7 parts of the DBE-5 solution containing the above-mentioned polymer (A-4) and 8.6 parts of the DBE-5 solution of the ethylenic unsaturated compound (B) obtained in Synthesis Example 2 and subjected to the evaluations of respective properties. The results are shown in Table 1.

### Synthesis Example 6

(Synthesis of Polymer (A-5))

To the vessel same as that used in Synthesis Example 1, 94 parts of propylene glycol monomethyl ether acetate was added as a solvent and after air in the vessel was replaced with nitrogen gas for 10 minutes, the solvent was heated to 110° C. while being stirred. A solution obtained by mixing 107.6 parts of N-phenylmaleimide, 149.3 parts of 2-hydroxypropyl methacrylate, 43.1 parts of styrene, and 287 parts of propylene glycol monomethyl ether acetate was added into one funnel. A solution obtained by mixing 9 parts of above-mentioned V-59 and 90 parts of propylene glycol monomethyl ether acetate was added into the other funnel. Thereafter, polymerization was carried out in the same manner as Synthesis Example 1. A solution containing 38.9% of a copolymer of N-phenylmaleimide: 2-hydroxypropyl methacrylate:styrene=30:50:20 (mole ratio) having Mw of 21000 was obtained.

Next, carboxyl group introduction reaction was carried out in the same manner as Synthesis Example 1 using the entire amount of the above-mentioned copolymer solution, 142 parts of tetrahydrophthalic anhydride, and 0.24 parts of benzyltriethylammonium chloride. As a result, a solution containing 48.4% of a copolymer having the introduced carboxyl group with an acid value of 118 mgKOH/g was obtained.

Next, ethylenic unsaturated double bond introduction reaction was carried out in the same manner as Synthesis Example 1 using 100 parts of the above-mentioned copolymer solution, 3.19 parts of glycidyl methacrylate, 0.04 parts of methylhydroquinone, and 0.03 parts of benzyltriethyl ammonium chloride. As a result, a propylene glycol monomethyl ether acetate solution containing 50.0% of a polymer (A-5), having an acid value of 86 mgKOH/g, and consisting of 0.044 mole of ethylenic unsaturated double bond per 100 parts by mass of the polymer was obtained.

### Example 6

(Preparation of Photosensitive Resin Composition and Evaluation of Properties)

A resin composition was obtained by mixing 11.6 parts of the propylene glycol monomethyl ether acetate solution containing the above-mentioned polymer (A-5) and 8.6 parts of the DBE-5 solution of the ethylenic unsaturated compound (B) obtained in Synthesis Example 2 and subjected to the evaluations of respective properties. The results are shown in Table 1.

### Synthesis Example 7

(Synthesis of Polymer for Comparison (A′-1))

Ethylenic unsaturated double bond introduction reaction was carried out the same manner as that in Synthesis Example 1 except that the reaction was performed using 100 parts of the solution containing 46.3% of the copolymer having an acid value of 122 mgKOH/g and having the introduced carboxyl group, which was obtained in the middle of the synthesis of the polymer (A-1) in Synthesis Example 1, 4.12 parts of glycidyl methacrylate, 0.03 parts of methylhydroquinone, 0.02 parts of benzyltriethyl ammonium chloride, and 1.03 parts of DBE-5. As a result, a DBE-5 solution containing 48.0% of a polymer (A′-1), having an acid value of 81 mgKOH/g, and containing 0.058 mole of ethylenic unsaturated double bond per 100 parts of the polymer was obtained.

### Comparative Example 1

(Preparation of Photosensitive Resin Composition and Evaluation of Properties)

A resin composition was obtained in the same manner as Example 1 except that the solution containing the polymer (A′-1) was used in place of the solution containing the polymer (A-1) and subjected to the evaluations of respective properties. The results are shown in Table 1.

### Synthesis Example 8

(Synthesis of Polymer for Comparison (A′-2))

Ethylenic unsaturated double bond introduction reaction was carried out the same manner as that in Synthesis Example 1 except that the reaction was performed using 100 parts of the solution containing 46.4% of the copolymer having introduced carboxyl group with an acid value of 138 mgKOH/g, which was obtained in the middle of the synthesis of the polymer (A-3) in Synthesis Example 4, 4.40 parts of glycidyl methacrylate, 0.03 parts of methylhydroquinone, 0.02 parts of benzyltriethylammonium chloride, and 1.55 parts of DBE-5. As a result a DBE-5 solution containing 48.0% of a polymer for comparison (A′-2), having an acid value of 92 mgKOH/g, and consisting of 0.061 mole of ethylenic unsaturated double bond per 100 parts by mass of the polymer was obtained.

### Comparative Example 2

(Preparation of Photosensitive Resin Composition and Evaluation of Properties)

A resin composition was obtained in the same manner as Example 1 except that the above-mentioned solution containing the polymer (A′-2) was used in place of the solution containing the polymer (A-1) and subjected to the evaluations of respective properties. The results are shown in Table 1.

### Comparative Example 3

A DBE-5 solution containing the ethylenic unsaturated compound (B) synthesized in Synthesis Example 2 (containing no polymer (A)) was subjected to the evaluations of respective properties. The results are shown in Table 1.

TABLE 1

| | Properties of | | | | | | | | |
|---|---|---|---|---|---|---|---|---|---|
| | polymer (A) (or A′) | | The amount of | | | | | | |
| | | The amount of | double bond in | | | | Flexibility | | |
| | Acid value | double bond¹⁾ | resin composition²⁾ | | | Tg | | After heat | |
| | (mgKOH/g) | (mole) | (mole) | Developability | Photo-curability | (° C.) | Un-treated | treatment | Adhesiveness |
| Example 1 | 89 | 0.045 | 0.184 | ∘ | ∘ | 125 | ∘ | ∘ | ∘ |
| Example 2 | 88 | 0.044 | 0.184 | ∘ | ∘ | 128 | ∘ | ∘ | ∘ |
| Example 3 | 106 | 0.042 | 0.183 | ∘ | ∘ | 130 | ∘ | ∘ | ∘ |
| Example 4 | 102 | 0.045 | 0.184 | ∘ | ∘ | 131 | ∘ | ∘ | ∘ |
| Example 5 | 102 | 0.045 | 0.109 | ∘ | ∘ | 132 | ∘ | ∘ | ∘ |
| Example 6 | 118 | 0.044 | 0.172 | ∘ | ∘ | 134 | ∘ | ∘ | ∘ |
| Comparative | 81 | 0.058 | 0.190 | ∘ | ∘ | 126 | ∘ | x | Δ |
| Example 1 | | | | | | | | | |
| Comparative | 92 | 0.061 | 0.192 | ∘ | ∘ | 129 | ∘ | x | Δ |
| Example 2 | | | | | | | | | |
| Comparative | — | — | 0.299 | ∘ | ∘ | 130 | x | — | x |
| Example 3 | | | | | | | | | |

¹⁾the number of moles of ethylenic unsaturated double bond per 100 parts of the polymer (A) or polymer (A′)
²⁾the total number of moles of ethylenic unsaturated double bond of the polymer (A or A′) and the compound (B) per 100 parts of the total of the polymer (A or A′) and the compound (B)

From Table 1, the photosensitive resin compositions within the scope of the invention were found excellent in the developability and photo-curability and the cured coating films were found excellent in the flexibility and adhesiveness while keeping the high glass transition temperature. Accordingly, use of the photosensitive resin compositions of the invention could give the contradictory properties, that is, the heat resistance and the dimensions stability or decreased brittleness, of the cured products in good balance.

### INDUSTRIAL APPLICABILITY

A photosensitive resin composition of the invention is preferably usable as an alkali developable photosensitive resin composition for image formation in various kinds of applications of such as solder resist for a printed circuit substrate, etching resist, electroless plating resist, an insulating layer of a printed circuit substrate by a build-up method, liquid crystal display fabrication, and printing plate production.

What is claimed is:

1. A photosensitive resin composition containing a polymer (A) having an N-substituted maleimide group, a carboxyl group, and an ethylenic unsaturated double bond at a ratio less than 0.05 mole per 100 parts by mass of the polymer (A).

2. The photosensitive resin composition according to claim 1, wherein a constituent unit having the N-substituted maleimide group is contained in an amount of 15 to 60% by mole in 100% by mole of the polymer (A).

3. The photosensitive resin composition according to claim 1, containing the polymer (A) and an ethylenic unsaturated compound (B) other than the polymer (A).

4. The photosensitive resin composition according to claim 3, wherein at least a portion of the ethylenic unsaturated compound (B) is epoxy (meth)acrylate.

5. The photosensitive resin composition according to claim 1, wherein at least some of carboxyl groups of the polymer (A) are bonded to the main chain of the polymer (A) through one or more ester bonds.

6. The photosensitive resin composition according to claim 1 further comprising a compound (C) having two or more functional groups reactive on a carboxyl group in one molecule.
